(19) United States
(12) Patent Application Publication
(10) Pub. No.: US 2014/0321496 A1
(43) Pub. Date: Oct. 30, 2014

(54) DEVICE FOR SUPPLYING ENERGY TO MELTING FURNACES

(71) Applicant: SMS MEVAC GMBH, Essen (DE)

(72) Inventors: Jens Klahr, Duisburg (DE); Juergen Watterodt, Oberhausen (DE); Peter Foerster, Essen (DE); Cihangir Demirci, Krefeld (DE)

(21) Appl. No.: 14/358,519

(22) PCT Filed: Dec. 21, 2012
(86) PCT No.: PCT/EP2012/005321

§ 371 Date: May 15, 2014

(30) Foreign Application Priority Data
Dec. 23, 2011 (DE) 102011122320.0

(51) Int. Cl. H01R 13/629; F27B 14/02; F27B 14/06

(52) U.S. Cl. CPC H01R 13/629; F27B 14/061; F27B 14/02; F27B 2014/002
USPC 373/143; 439/259; 373/147

(57) ABSTRACT

The invention relates to a coupling device (2) for electrically connecting a melting furnace, in particular the crucible (1) of a melting furnace, to an energy source, comprising at least one contact body (6), which is connected to the energy source by means of high current cables (10), and at least one molded part (5) as part of an electrical receptacle (3) on the melting furnace, in particular the crucible (1), characterized in that a form-fitted and electrically conductive connection of the contact body (6) and the molded part (5) can be established by inserting the contact body (6) into the molded component (5). The invention further relates to a melting furnace, in particular an induction furnace and a vacuum induction melting furnace (VIM), comprising at least one such coupling device.

### FIELD OF THE INVENTION

The invention relates to a coupling system for electrically connecting a smelter, in particular the crucible of a smelter, to an electrical power source, where the coupling system comprises at least one contact connected by electrical cords or cables, preferably a high-current cable, and at least one counter contact as part of an electrical receptacle on the smelter, in particular crucible. Furthermore, the invention relates to a smelter, in particular an induction furnace or vacuum induction smelter (VIM), including at least one coupling system of this kind.

### PRIOR ART

Systems for supplying electrical power to smelters in which metals and non-ferrous (NF) metals or smelts are treated, particularly under vacuum, have long been known from the prior art. In order to supply electrical power, a plurality of preferably water-cooled high-current cables, which are supplied from an external power source, are connected to the smelters that are usually designed so that they can be raised and lowered and, if necessary, pivoted.

With the known smelters, which work under an oxygen-free atmosphere and are used particularly in secondary and tertiary metallurgy, the high-current cables, of which twelve with a diameter of about 110 mm are usually provided, are screwed directly to the crucible or fixed thereto by a screw connection. The high-current cables that are to be provided for the connection between the smelting power supply and the furnace are usually long and therefore hang outside the smelting chamber in a loop in order to ensure a necessary length compensation when the smelter or crucible is raised and lowered, for example when it is filled with scrap that is to be subsequently smelted inside the smelter or crucible by feeding in electrical power.

The length of the high-current cables therefore enables the required length compensation for the movement of the crucible due to the process, in particular when the crucible is changed, emptied or filled.

The brick lining, in particular the refractory lining, of such a smelter or crucible must be replaced approximately every week, for which purpose it is necessary to disconnect the smelter or crucible from the high-current cables. The extensive fitting work that is necessary for this takes a great deal of time. Also, faults in the operation can necessitate repair work with the system switched off, and the elaborate removal of the high-power cables from the smelter or crucible described above is required on a regular basis.

The disadvantages mentioned above can be avoided and, particularly when changing the crucible, considerable time can be saved and at the same time the fitting effort can be significantly reduced if the high-current cables were designed to be able to be coupled and uncoupled to/from the smelter or crucible with little or entirely avoidable fitting effort, in particular if they were to enable an automatic coupling and uncoupling.

### OBJECT OF THE INVENTION

It is therefore an object of the invention to provide a coupling system for the electrical connection of a smelter to an electrical power source, by means of which the fitting effort for coupling and uncoupling the high-current cables is restricted to a minimum or entirely avoided.

This object of the invention is attained by a coupling system that with the features of claim 1, and by a smelter with the features of claim 10. Advantageous embodiments of the invention are described down in the dependent claims.

### SUMMARY OF THE INVENTION

Within the meaning of the invention, an interlocking and electrically conducting connection of contact and countercontact can be effected by sliding the contact into the countercontact. First, this forms an automatic coupling and uncoupling of the high-current cable to the smelter or crucible, as a result of which the fitting effort that was previously necessary with electrical power supplies for smelters from the prior art is entirely avoided. Preferably, manual intervention by foundry workers can be completely avoided with a fully automatic coupling and uncoupling of the high-current cable.

The interlocking connection of contact and countercontact is achieved when an adequate surface contact between contact and countercontact effects an electrically conducting connection solely by sliding the contact into the countercontact. The required interlocking between contact and countercontact therefore applies to the achievable contact surface between contact and countercontact that must be sized and designed such that the electrical power feed from the electrical power source to the smelter or crucible can be achieved without unnecessary resistance.

It is particularly preferred when a fixing system that secures the interlocking and electrically conducting connection between the at least one contact and the at least one countercontact in the coupling position, is provided. In addition, it is preferred when this fixing system is provided in the form of a latch that is preferably provided in the form of at least one latch pawl that is connected to the contact and engages behind a latch formation connected to the countercontact or to the crucible itself. This creates a coupling system that ensures a reliable supply of electrical power to the smelter or crucible, even in the case of movement of the smelter or crucible due to the process. The fixing enables the coupling system to maintain the interlocking and electrically conducting connection between the contact and the countercontact, even when the smelter or crucible is pivoted through an angle greater than or equal to 90°, for example when tipping the melt out of the smelter or crucible.

Automation of the coupling system is advantageously increased, particularly when a traverse system for moving the at least one contact from a parking position into a coupling position is provided. It is particularly preferred when the traverse system has an electromechanical or pneumatic drive. However, it is more particularly preferred when the traverse system has a hydraulic drive. This not only enables a preferably fully automatic coupling and uncoupling of the high-current cable from the smelter or crucible, but also the preferably hydraulic drive allows the at least one contact to be moved into the coupling position or away therefrom using operating equipment that is provided in any case and is therefore easily available.

It is particularly preferred when the coupling system has more than one (1), preferably six (6), contacts, and more than one (1), preferably six (6), complementarily shaped countercontacts. This way, a coupling system is created with which the electrically conducting connection is made by a multiplicity of contact surfaces between contact and countercontact that guarantee that current is fed from the electrical power source to the smelter or crucible.

In addition, it is preferred when the at least one contact is mechanically, hydraulically or pneumatically forced onto the at least one countercontact in the coupling position. It is particularly preferred when, at least in the coupling position, the at least one contact is pushed into the interlocking and electrically conducting connection with the at least one countercontact under the action of a prestressed spring. This provides a secure electrical connection of the smelter or crucible to the electrical power source that is also able to compensate for any bending loads or deformations at least of parts of the coupling system that may be present or may occur without a readjustment of the coupling system or a repeated actuation of the traverse system being necessary.

It is particularly preferred when the at least one countercontact has a socket for the contact, preferably a socket with centering function, for example in the shape of a wedge. In this regard, it is particularly preferred when the receptacle has the shape of a negative frustocone and the contact the shape of a positive frustocone. By this means, self-centering of the coupling system and of its parts relative to one another is effected solely by sliding the contact from a parking position into the coupling position. In addition, this creates peripheral contact surfaces between contact and countercontact that also allow a reliable and permanent electrical connection of the smelter or crucible to the electrical power source even under the action of mechanical vibrations or other forces on the coupling system.

According to a further aspect of the invention, a smelter including a coupling system according to the first aspect of the invention is provided. It is particularly preferred when the smelter is an induction furnace, by means of which metals and nonferrous (NF) metals can be smelted and brought to the required temperature.

It is also preferred when the smelter, in particular the crucible of the smelter, is designed to be able to be tilted through an angle of greater than or equal to 90°, preferably of up to 180°. This creates a smelter that enables complete emptying and, at the same time, better access to the furnace interior without it being absolutely essential to disconnect the coupling system. In any event, as a result of the preferably automated coupling of the high-current cable to the smelter or crucible, the smelter or crucible can also be tilted quickly and without major fitting effort even when the coupling system is disconnected.

### BRIEF DESCRIPTION OF THE FIGURES

The invention is explained in more detail below with reference to three figures in which preferred embodiments of the invention are shown. In the figures,

FIG. 1 shows the connection of a coupling system according to the invention in a first embodiment of the invention based on a sequence of five working steps,

FIG. 2 shows the connection of a coupling system according to the invention in a second embodiment of the invention based on a sequence of five working steps, and

FIG. 3 is a side view of a coupling system according to the invention in a third embodiment of the invention.

### DETAILED DESCRIPTION OF THE FIGURES

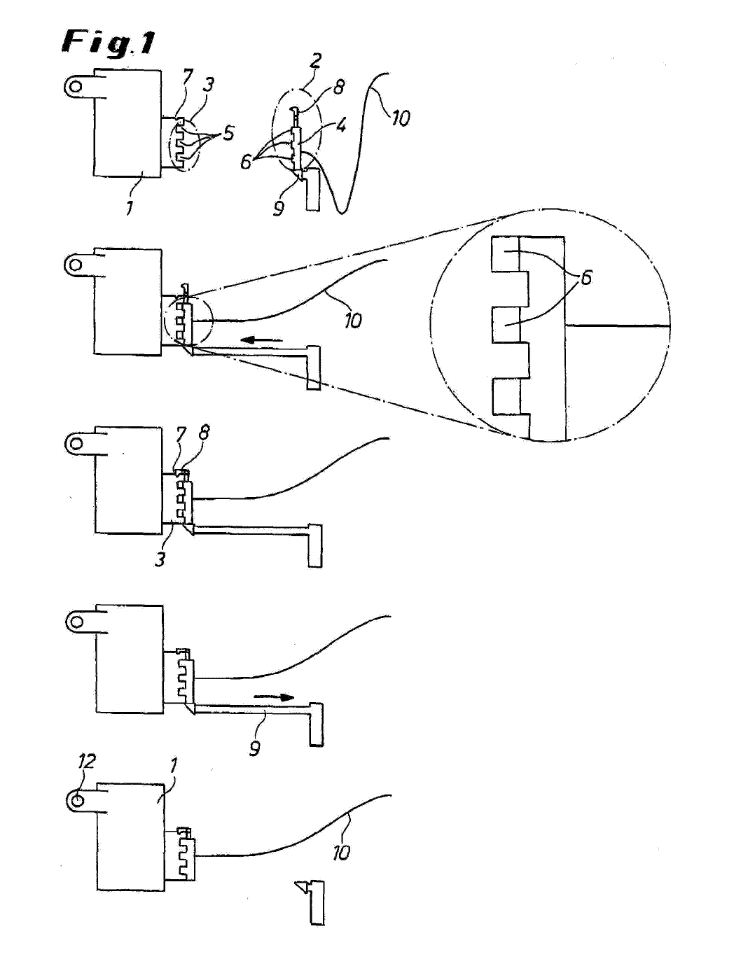

In a sequence of five views, FIG. 1 shows the principle of operation of a first embodiment of the coupling system according to the invention, by means of which a power cable 10, which is connected to a contact support 4 that has a plurality of contacts 6, can be connected to an electrical receptacle 3 that has a plurality of contact countercontacts 5. In a parking position remote from the smelter 1, the contact support 4 is part of a coupling assembly 2 that can be moved backward and forward in the direction of the arrows shown in the views and, if necessary, also rotated and temporarily fixed on a traverse system 9. To mate with the receptacle 3 the complementarily indented contact support 4 to which the power cable 10 is connected has the contacts 6. A hook-like fixing means 8 in the form of a latch pawl that, in the coupled state, engages behind a latch formation 7 at least at the upper end of the contact support 4. Preferably, the latch pawl 8 is actuated from above, for example hydraulically, and can engage behind the latch formation 7 to fix together of the coupling system. The coupling system and its components are preferably controlled with or without feedback by a plurality of media connections supplied from a controllers. The interlocking coupling with the fixing and, if applicable, the hydraulic or pneumatic locking are described in more detail below with reference to the views in FIG. 1. As soon as the smelter 1 has reached its coupling position shown at the top in FIG. 1, the coupling process starts in order to make the connection with the contact countercontacts 5 on the side of the smelter. The traverse system 9 moves the coupling system from the parking position toward the smelter 1 until the contacts 6 make interlocking and electrically conducting contact with the countercontacts 5. The interlocking contact with the countercontacts 5 with the contacts 6 can be seen enlarged in the section drawing of the second view in FIG. 1. As can be seen in the third view in FIG. 1, the latch pawl 8 is then pivoted so that it engages in the latch formation 7 on the electrical receptacle 3, and thereby fixes of the coupling system overall. The traverse system 9 can then be moved back out of its contact position into the parking position shown in the fifth view, as a result of which, a supply of power to the smelter 1 is finally effected by the electrical power source (not shown) via the power cable 10 that, at the same time, allows the smelter 1 to swivel about a pivot 12.

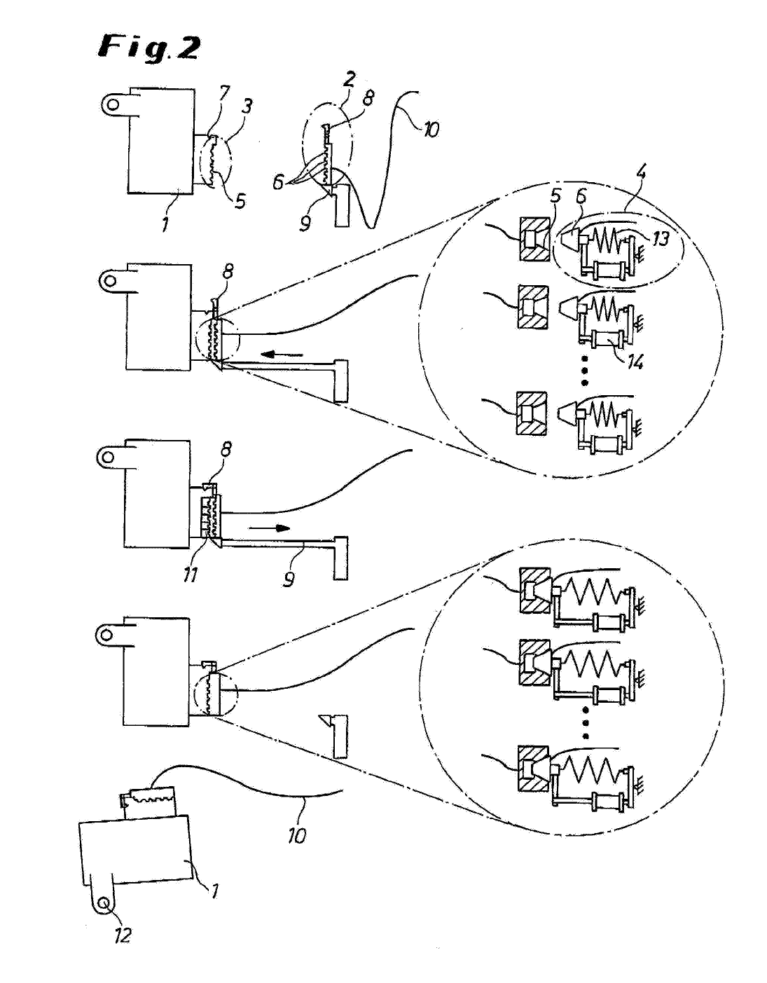

In a sequence of five views, FIG. 2 shows the principle of operation and the embodiment of the coupling system according to the invention by the multiconductor high-current cable 10 connected to a plurality of contacts 6 on the contact support 4. In a parking position remote from the smelter/crucible 1, the contact support 4 and it's a coupling assembly 2 be moved backward and forward in the direction of the arrows shown in the views and, if necessary, also rotated and temporarily fixed on the traverse system 9.

The contact support 4, in particular the individual contacts 6, and the complimentary form of the electrical receptacle 3, in particular of its countercontacts 5, differ only in their shape. As can be easily seen from the enlarged illustrations of views 2 and 4 in FIG. 2, the countercontacts 5 substantially have the shape of a negative frustocone and the contacts 6 have a complementary frustoconical shape so that a self-centering of the individual contacts 6 within the receptacles 11 of the countercontacts 5 can be effected when the contact position of the coupling system is reached. In addition, the individual contacts 6 can be forced into the contact position within the receptacles of the countercontacts 5 by respective springs 13 that are pre-stressed by suitable positioning elements 14, for example hydraulically or pneumatically actuated, in order to safely ensure a reliable and permanent surface contact between the contacts 6 and the countercontacts 5 even when mechanical vibrations occur within the coupling system. In addition, view 5 in FIG. 2 shows how, in spite of the high-current cable 10 connected to the smelter/crucible 1, the smelter/crucible 1 can be pivoted about its pivot point 12 by more than 90° in order to pour out the smelt in the smelter/crucible 1. The decoupling or disconnection of the high-current cable 10 is carried out in the reverse order to the coupling/connection described above. The traverse system 9 moves underneath the coupling system that is temporarily fixed and locked to the smelter/crucible 1. The connection between the contacts 6 and the countercontacts 5 on the smelter side is released, as is then likewise the locking pawl 8. The coupling system thus released is then moved back into the parking position by the traverse system 9. As the coupling and uncoupling can preferably be carried out automatically and in very much shorter time, a simultaneous saving in material can also be achieved. This is because the thick, expensive high-current cable 10 can be of significantly shorter length, as it is no longer necessary to compensate for the length if the coupling system is disconnected before every swiveling of the furnace 1. Namely, the electrical power supply can be automatically uncoupled and then re-coupled easily and in a timely manner when the smelter/crucible 1 changes position, as also when lowering or raising for filling with scrap.

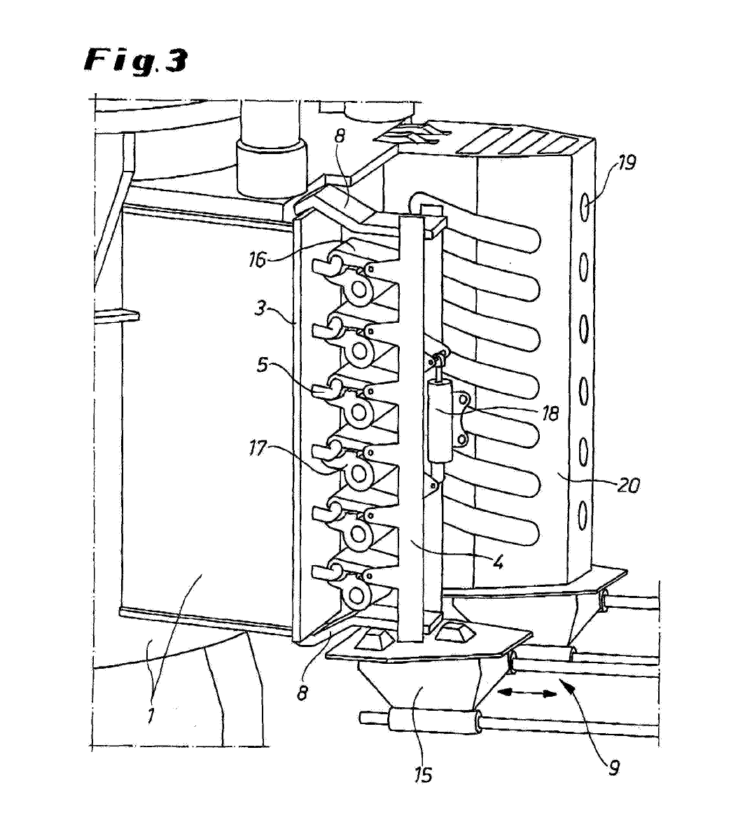

FIG. 3 shows a third embodiment of the coupling system according to the invention, where an outer side of the smelter 1 or crucible has a rectangular, plate-shaped receptacle 3 with preferably clip-like current-carrying or conducting molded counter contacts 5 that, like the crucible 1 itself, are made of copper. Of these, advantageously, two rows are provided, each with six contacts 5 that lie above one another and with clearance from one another. An arrangement of for example hydraulically actuated contacts 6, which can be moved backward and forward on a linear guide, is associated with the two vertical rows of contacts 5.

These contacts are carried on two movable slides 15, which can be moved preferably on separate respective linear guides and that therefore can be moved independently of one another, with contacts 6 that are designed as multi-core power cable connecting elements corresponding to the number of power cable provided and therefore to the number of clip-shaped molded pieces 5, and are carried by the slides. Upper contact jaws 16, with which lower contact jaws 17 mounted on the clip-shaped molded pieces 5 are associated and that are rotatably mounted in the contacting systems 6, are provided from the front, i.e. projecting toward the smelter 1, on the front side of the contacting systems in the direction of movement facing the clip-like counter contacts 5. An upper and lower fixing hook 8 are mounted so that they can swivel about horizontal axes at the head and foot end of the contacting system 4. When the contacts 6 have moved up to the smelter 1, the fixing hooks or latch pawl 8 engage above or below the plate-shaped receptacle 3 of the contacts 5 and are then connected thereto in an interlocking and centered manner. The centered clamping position is interlocked, for example by a double-acting hydraulic cylinder 18 that is carried on the contacting system 4 and can be connected to the fixing hook 8 by a linkage. The contacting system 4 can be enclosed by a housing 20 that has through holes 19 for the power cable 10 and that also serves to provide protection against damage. In order to provide electrical power to the smelter 1, which is in its operating position for handling the smelt, the coupling system with the ends of the power cable 10, which are fixed in the contacting system 4, is moved by the traverse system 9 out of its parking position toward the smelter 1, and the contacting system 4 is fixed and locked in an interlocking manner to the plate-like receptacle 3 with the contacts 5 by the fixing hooks 8. The pair of pincer-like contact jaws 16, 17 of each contact 6 clamps the clip-like molded pieces of the counter contacts 5, whereupon current can flow via the power cable and the clip-like contacts 5 into the smelter 1. After the contact system 4 or contact surfaces 6 have been clamped in this way, the slides 15 of the traverse system 9 are moved back into the parking position. The handling of the melt in the furnace 1 can begin, and the contact jaw pairs 16, 17, which on the one hand are clamped to the clip-like power parts 5 and locked there and, on the other, swivel in their mountings on the contacting systems or contacts 6, allow for the operation of the smelter with lift and swivel movements. In turn, the power cable 10 are likewise uncoupled in reverse order to the coupling described above. The traverse system 9 moves the slides 15 out of the parking position under the contacts 6 of the coupling system that are temporarily fixed to the smelter 1. The connection between the clip-like molded pieces or contacts 5 of the smelter side and the contact jaw pairs 16, 17 of the contacts 6 is disconnected, as is the locking of the fixing hooks 8. The slides 15 take over the contacting system 4, and the contacts 6 are moved back into the parking position. The traverse system 9, which is not shown, can be actuated by a hydraulic cylinder. The shown coupling or contact person can also see that the contacting systems 4, of which the front one is shown without a protective housing 20, are centered in an interlocking manner by a top and a bottom fixing hook 8 on the plate-shaped receptacle 3 of the smelter 1 and are locked by hydraulic cylinders 18 arranged in the contact systems 4. In conjunction with the lower contact jaws 17 of the contacts 6, which are fixed to the contacts 5, the upper contact jaws 16 of the contacts 6 as contact clamps grip the respective clip-like sections of the molded pieces or contacts 5. Here, the upper contact jaws 16 can be deployed hydraulically (not shown) against the lower contact jaws 17 such that the half-shell-like front ends of the contact jaws 16, 17 engage safely around the contacts 5. The protective housing 20, which is located at the back in the plane of the drawing and surrounds the contacting system 4, enables the passage for the power cable 10 to be seen.

### LIST OF REFERENCES

1 Crucible
2 Coupling system
3 Electrical receptacle
4 Contact support
5 Countercontact
6 Contact
7 Latch formation
8 Locking system
9 Traverse system
10 High-current cable
11 Receptacle
12 Pivot point

1. A coupling system for electrically connecting a smelter to an electrical power source, the coupling system comprising:
at least one contact connected to the electrical power source by a high-current cable
at least one countercontact as part of an electrical receptacle on the smelter,
means for interlocking and electrically conducting connecting the contact and the countercontact by sliding the contact into the countercontact; and
a traverse system is provided for moving the at least one contact from a parking position with the at least one contacts spaced from the at least one countercontact into a coupling position with the at least one contacts engaging the at least one countercontact.

2. The coupling system as claimed in claim 1, further comprising:
a locking system between the at least one contact and the at least one countercontact.

3. The coupling system as claimed in claim 2, wherein the locking system includes at least one latch pawl that engages behind a latch formation and is connected to the contact.

4. (canceled)

5. The coupling system as claimed in claim 1, wherein the traverse system has an electromechanical, a pneumatic or preferably a hydraulic drive.

6. The coupling system as claimed in claim 1, wherein there are more than one contacts, and more than one complementarily shaped countercontacts.

7. The coupling system as claimed in claim 1, wherein the at least one contact is mechanically, hydraulically or pneumatically forced onto the at least one countercontact in the coupling position.

8. The coupling system as claimed in claim 1, wherein the at least one countercontact is a socket for the contact with centering function.

9. The coupling system as claimed in claim 8, wherein the socket has the shape of a negative frustocone and the contact the shape of a positive frustocone.

10. A smelter, in particular induction furnace, including at least one coupling system as claimed in claim 1.

11. The smelter as claimed in claim 10, wherein the smelter, in particular the crucible of the smelter, can be tilted through an angle of greater than or equal to 90°.
